(19) United States
(12) Patent Application Publication
(10) Pub. No.: US 2015/0302108 A1
(43) Pub. Date: Oct. 22, 2015

(54) COMPILATION OF ENCAPSULATED CONTENT FROM DISPARATE SOURCES OF CONTENT

(71) Applicants: Mehul Trivedi, San Francisco, CA (US); Vivek Agrawal, San Francisco, CA (US)

(72) Inventors: Mehul Trivedi, San Francisco, CA (US); Vivek Agrawal, San Francisco, CA (US)

(73) Assignee: AliphCom, San Francisco, CA (US)

(21) Appl. No.: 14/578,297

(22) Filed: Dec. 19, 2014

Related U.S. Application Data
(60) Provisional application No. 61/918,655, filed on Dec. 19, 2013.

(51) Int. Cl. G06F 17/30

(52) U.S. Cl. CPC G06F 17/30905; G06F 17/30867

(57) ABSTRACT

Embodiments relate generally to electrical and electronic hardware, computer software, wired and wireless network communications, and media devices or wearable/mobile computing devices configured to facilitate presentation of content in a summarized form. More specifically, disclosed are systems, devices and methods to encapsulate or summarize a pool of content, such as music or audio tracks, in digest form. In some embodiments, a method may include identifying a pool of content as a function of a subset of parameters, selecting a subset of content from the pool based on one or more of the parameters to compile data representing encapsulated content, and forming data representing a digest of the pool of content including the compiled encapsulated content. Further, the method may include presenting the data representing the digest of the pool of content.

### RELATED APPLICATIONS

This application claims the benefit of U.S. Provisional Patent Application No. 61/918,655 filed Dec. 19, 2013 with Attorney Docket No. ALI-349P, which is herein incorporated by reference. This application incorporates the following applications herein by reference. U.S. Provisional Patent Application No. 61/864,265 filed on Aug. 5, 2013 and entitled “System and Method for Personalized Recommendation and Optimization of Playlists,” U.S. Provisional Patent Application No. 61/844,488 filed on Jul. 10, 2013 and entitled “System and Method for Audio Processing Using Arbitrary Triggers,” and U.S. patent application Ser. No. 14/039,258 filed on Sep. 27, 2013.

### FIELD

Embodiments relate generally to electrical and electronic hardware, computer software, wired and wireless network communications, and media devices or wearable/mobile computing devices configured to facilitate presentation of content in a summarized form. More specifically, disclosed are systems, devices and methods to encapsulate or summarize a pool of content, such as music or audio tracks, in digest form.

### BACKGROUND

Conventional content delivery services, such as networked-based music streaming services, enable consumers of content to readily access content, such as video, audio, and the like, via a network (e.g., the Internet). A multitude number of different content delivery providers and services are available from which to receive streaming content, such as streaming audio. Users and consumers of content from these different content delivery services may, in some cases, find management of their collections of music unwieldy.

While the conventional approaches are functional, there are various drawbacks to using conventional networked-based content streaming services. At least one drawback is that different content delivery services provide streaming content using proprietary processes, thereby usually requiring the use of specific application programming interfaces (“APIs”) to access content, as well as to manage or create personalized collections of content, such as playlists.

Another drawback is that access to collections of content, such as curated groupings of content (e.g., sponsored playlists), generally is provided in toto. For example, a grouping of content is generally formed by an entity that creates data sets (e.g., data representing playlists) that are monolithic in structure and/or function, or as a continuous flow of predetermined content. Relatively large-sized groupings of content are typically difficult to consume. For example, a potential consumer of a playlist of 300 or more audio tracks generally finds it difficult to ascertain whether that consumer is interested in obtaining such a playlist. Therefore, a curator of such a playlist may receive less interest in the playlist due to the difficulty by consumers to determine the desirability of the content.

Thus, what is needed is a solution for compiling encapsulated content from a pool of content in digest form, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 illustrates an example of an encapsulated content generator, according to some embodiments;

FIGS. 2A to 2C are diagrams depicting examples of generating, arranging, and or disposing samples in a digest, according to some examples;

FIG. 3 is a diagram depicting examples of devices in which, or over which, structures and/or functions of an encapsulated content generator can be disposed, according to some embodiments;

FIG. 4 is a diagram depicting an example of a content retriever, according to a specific example;

FIG. 5 is a diagram depicting a process of forming a digest, according to some examples;

FIG. 6 is a diagram depicting a presentation engine, according to some examples;

FIG. 7 is a diagram depicting a revised subset of samples, according to some examples;

FIG. 8 is an example flow of generating encapsulated content for a pool of content, according to some embodiments; and

FIG. 9 illustrates an exemplary computing platform in accordance with various embodiments.

### DETAILED DESCRIPTION

Various embodiments or examples may be implemented in numerous ways, including as a system, a process, an apparatus, a user interface, or a series a program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

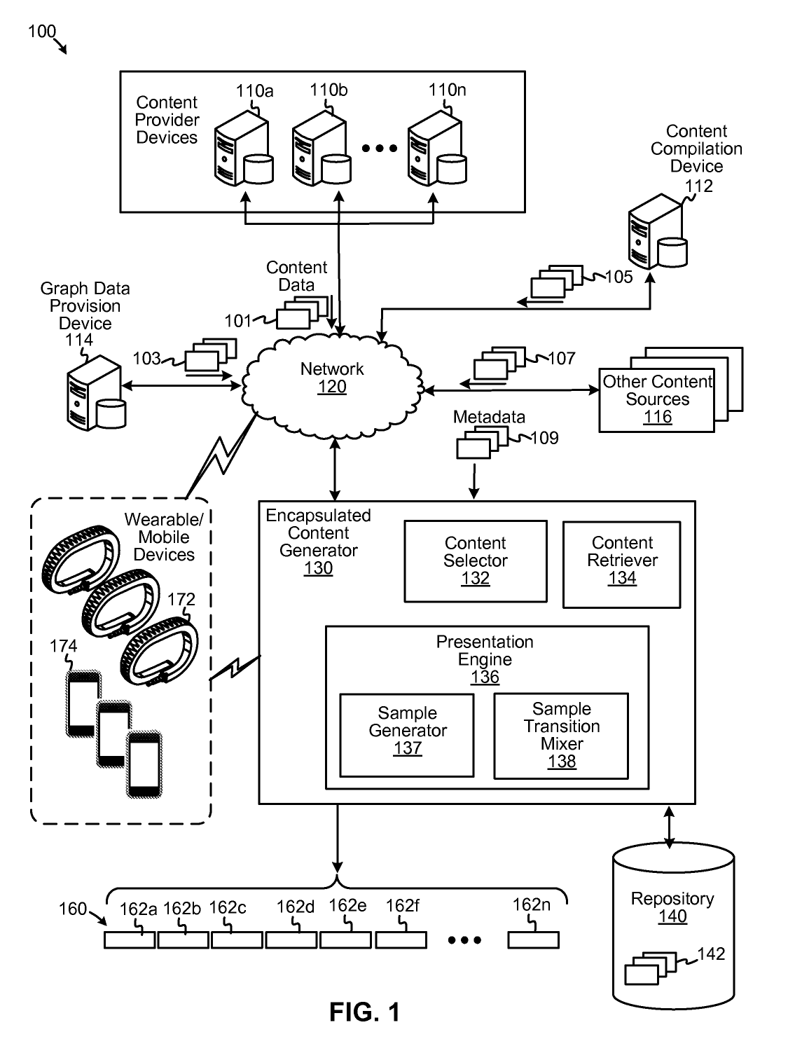

FIG. 1 illustrates an example of an encapsulated content generator, according to some embodiments. An encapsulated content generator 130 of diagram 100 is configured to create a summary of content in a pool of content, at least some of which originate in disparate sources of content. Encapsulated content generator 130, therefore, is configured to select a subset of content from the pool based on one or more of the parameters to compile data representing encapsulated content. A digest of the pool if content can be formed based on a compilation of encapsulated content (e.g., summarized content), and presented to a user, listener, and/or consumer of the content. According to various examples, content can be data representing music and/or audio tracks. Therefore, encapsulated content generator 130 can generate a universal preview of music for any collection of songs from different music streaming services. The universal preview of music, which is a digest, can include portions from, for example, 10 to 40 audio tracks that are selected as being the most relevant in view of certain parameters, such as the number of times a song was played, a number of friends, family members, acquaintances, and the like, that played the song, etc. The portions of the audio tracks that compiled into the digest, can be, for example, 30 seconds of music. The universal preview of music can be formed as a media file, such as in readily available audio file type (e.g., MP3 or the like). A specific example, a digest can represent a “year-in-review” of content consumed by one or more users over the duration of a year.

Diagram 100 further depicts disparate content provider devices 110a to 110n that are configured, among other things, to host audio/music streaming services, which is accessible via network 120 to encapsulated content generator 130. Data 101 representing contents such as audio tracts or music tracks (e.g., songs), as well as metadata, from content provider devices 110a to 110n can be transmitted to encapsulated content generator 130. In some cases, a content compilation device 112 can provide a compilation or collection of content of entire units of content, such as entire songs. For example content compilation device 112 can be used to curate specialized playlists that may be accessed or otherwise consumed by encapsulated content generator 130. As shown, content compilation device 112 can transmit data 105 representing playlists, audio tracks, metadata, and the like, to encapsulated content generator 130. Graph data provision device 114 is configured to transmit data 103 includes parameters, social relationship associations, audio-related information (e.g., listening histories, archive data of songs played, frequencies that songs are played, album information, song identifiers (“IDs”), etc.). In some cases, graph data provision device 114 may be hosted by a social networking service that maintains data specific to its users and its users' activities and events, including archived events related to the playback of audio/songs. Content can also come via data 107 from other content sources 116. According to some embodiments, at least one content source in other content sources 116 provides samples or portions of content, such as portions of audio tracks or songs that are accessible by encapsulated content generator 130. In some cases, audio data 107, which can include metadata, etc., is provided without cost to enable users or consumers to sample or determine the desirability of particular piece of content.

As shown, encapsulated content generator 130 includes a content selector 132, a content retriever 134, and a presentation engine 136, which, in turn, includes a sample generator 137 and a sample transition mixer 138. Encapsulated content generator 130 is configured to receive data, such as parameter data 142, from a repository 140. Encapsulated content generator 130 may also receive data representing audio, content, control information, parameters, and the like, from wearable devices 172 and mobile computing devices 174. Metadata 109 can be received by encapsulated content generator 130 from any of the above-described elements of devices. One or more components of encapsulated content generator 130 cooperate to generate a digest 160 of the pool of content (or from a pool of selected content, the selection being based on one or more parameters). As shown, digest 160 can include portions 162a to 162n of content that are presented to a user. Portions 162a to 162n of content can be presented serially to a user or consumer, or in parallel, as the case may be. In some examples, one or more portions 162a to 162n of content may represent encapsulated content in which content (e.g., a digitized song or music) is converted or otherwise transformed into data representing a sample of the content and/or a summarized version of the content (e.g., a portion of the digitized song or music).

Content selector 132 is configured to determine a subset of the pool of content from which generated encapsulated content. For example, content selector 132 can select songs as a function of data, such as metadata 109 and other metadata, parameter data, contextual data, physiological data from wearable devices 172, sensor data from wearable device 172, and the like. Metadata 109 (in other metadata) can include extraneous data associated with the content. In cases in which content includes audio, the metadata can include a song ID, an album identifier, an artist identifier, length of a song, a genre association, etc. Metadata may also include parameters and the like. In some cases, parameters can include musical characteristics, such as tempo, beat phase, key, time signature, beats per minute, amount of bass, etc, parameter data can include contextual data, such as the average time of day of archived consumption, time of present consumption, proximity to another user or object (e.g., city or place, such as a house or wireless signal origination point), within a same room (e.g., proximity of less than 30 in between a user and other individuals, such as friends, members, etc.), geographic location, a social relationship association or affinity (e.g., whether an association identifies a relationship as a friend, a family member, coworker, an acquaintance, and the like), etc. Parameter data can also include an indication of favorite (e.g., most favorite). Parameter data can also include biological or physiological-sense data, such as heart rate, respiration rate, temperature, GSR, and other user-specific data that can be derived, such as an archived activity (e.g., running, sleeping, swimming, etc.), a presently-engaged activity, a mood, energy level (e.g., whether engaged in dancing in a party), etc. In some cases, metadata and/or parameters can include social-related data such as a listing history of songs and other content information from a social networking service (“SNS”). SNS-specific song identifiers, the frequency of consumption for each song, etc.

Content selector 132 is configured to use any of the above-described parameters, as well as other parameters and criteria, to form a subset of content for presentation. When generating a “year-in-review,” content selector 132 is configured to select a number of songs having the highest frequency of playback over the duration of one year, for example.

Content retriever 134 is configured to retrieve content from one or more sources of content in view of content selector 132 determining a subset of songs for presentation. For example, content selector 132 may identify ten (10) songs for presentation (e.g., audio presentation), and content retriever 134 may be configured to retrieve 30-second samples of those ten songs from content sources, such as other content sources 116.

Presentation engine 136 is configured to arrange the portions of content in a digest, and adapt those portions to each other in a sequence (or any other arrangement) to present the digest of content m a manner that may be pleasing to the listener or consumer of content generally. As shown, presentation engine 136 includes a sample generator 137 that is configured to arrange the encapsulated. content (e.g., portions of content) in arrangement shown as portions 162a to 162n. Sample transition mixer 138 is configured to perform beat-matching, cross-fading, time-shifting, bit-shifting, as well as adjusting, for example beats-per-minute, key, and other musical characteristics between at least two portions or samples to effectively compile the sampled audio in an arrangement that is fluid and perceptibly pleasing, or at least cohesive. In particular, sample transition mixer 138 is configured to avoid or minimize samples of songs that are mismatched. For example, sample transition mixer 138 first may likely seek to avoid placing a sample a hard rock music before a sample of a lullaby music, and second, if necessary, modify (i.e., soften) the transition from hard rock to lullaby music, by, for example, reducing base, volume, shifting key, and slowly adapting beats per minute, among other things.

In some embodiments, encapsulated content generator 130 can be in communication (e.g., wired or wirelessly) with a mobile device 174, such as a mobile phone or computing device. In some cases, a mobile device or any networked computing device (not shown) in communication with a wearable computing device including encapsulated content generator 130 can provide at least some of the structures and/or functions of any of the features described herein. As depicted in FIG. 1 and other figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1 (or any figure) can represent one or more algorithms. Or, at least one of the elements can represent a portion of logic including a portion of hardware configured to provide constituent structures and/or functionalities.

For example, encapsulated content generator 130 and any of its one or more components, such as content selector 132, content retriever 134, and presentation engine 136, which, in turn, may include sample generator 137 and sample transition mixer 138, can be implemented in one or more computing devices (i.e., any audio-producing device, such as desktop audio system (e.g., a Jambox® optionally implementing LiveAudio® or a variant thereof)), a mobile computing device, such as a wearable device or mobile phone (whether worn or carried), that include one or more processors configured to execute one or more algorithms in memory. Thus, at least some of the elements in FIG. 1. (or any figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arras (“FPGAs”), application-specific integrated circuits (“ASICs”), multi-chip modules, or any other type of integrated circuit. For example, encapsulated content generator 130 and any of its one or more components, such as includes a content selector 132, a content retriever 134, and a presentation engine 136, which, in turn, includes a sample generator 137 and a sample transition mixer 138 can be implemented in one or more computing devices that include one or more circuits. Thus, at least one of the elements in FIG. 1 (or any figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms or software-based modules. These can be varied and are not limited to the examples or descriptions provided.

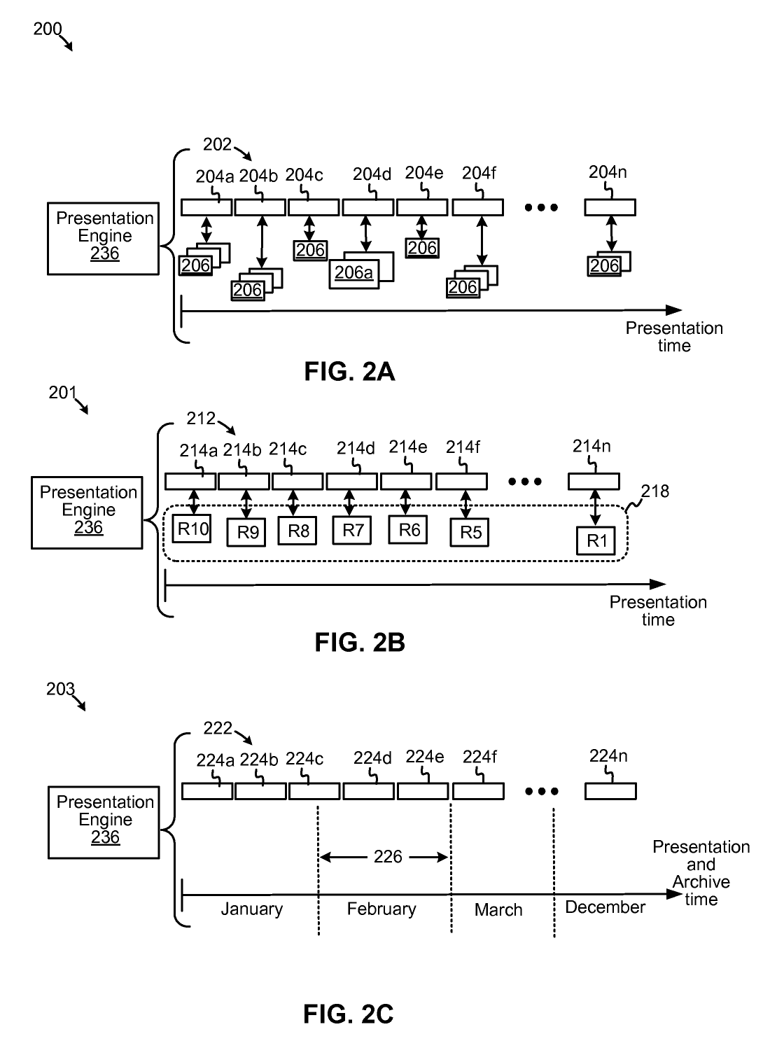

FIGS. 2A to 2C are diagrams depicting examples of generating and/or disposing samples in a digest, according to some examples. Diagram 200 of FIG. 2A depicts a presentation engine 236 configured to generate a digest 202 that includes portions 204a to 204n of different songs for presentation (e.g., sequentially) to a user or consumer of content. In this example, presentation engine 236 is configured to present other forms of content 206 that coincide or substantially coincide with a presentation of individual portions 204a to 204n. Other forms of content 206 can include emails, texts, tweets (or other character-limited texts), photos, videos, telephone calls and related information, indications of an activity performed, and the like. For example, if a listener/user/consumer graduated from college in June, the listener might expect to hear most-frequently played song samples (e.g., songs previously played in June or adjacent thereto, such as in May or July), such as sample 204d, along with other timeframe/event-related content, such as photos 206a of the graduation in June, congratulatory emails 206a associated with June (or the event of graduating), videos 206a, visual content 206a from friends' social networking services, and the like.

FIG. 2B is a diagram 201 that depicts a presentation engine 236 configured to generate as digest 212 that includes portions 214a to 214n of songs for presentation to a user or consumer of content, according to some examples. In this example, presentation engine 236 is configured to present portions 214a to 214n in order (i.e., reverse order) of the rankings (e.g., “R1” is ranked first, and “R10” is ranked tenth). Therefore, a presentation engine 236 is configured to provide to countdown-like presentation of content (e.g., a “top ten” sampling of content over a duration, such as a year).

FIG. 2C is a diagram 203 that depicts a presentation engine 236 configured to generate a digest 222 that includes portions 224a to 224n of songs for presentation to a user or consumer of content, according to some examples. In this example, presentation engine 236 is configured to present portions 214a to 214n in a temporal order. Thus, while the songs associated with portions 224a to 224n may be the most-played songs over a year, presentation engine 236 is configured to present the portions corresponding to a month 226 (or adjacent to the month) in which the highest frequency of playback occurs. As shown, samples 224d and 224e were played the most in February, and, thus, can be disposed in digest 222 and a corresponding timeline of a “year-in-review.” in at least these examples, the terms “portion” or “sample” can refer, in some cases, to encapsulated content, which can be compiled to form a digest.

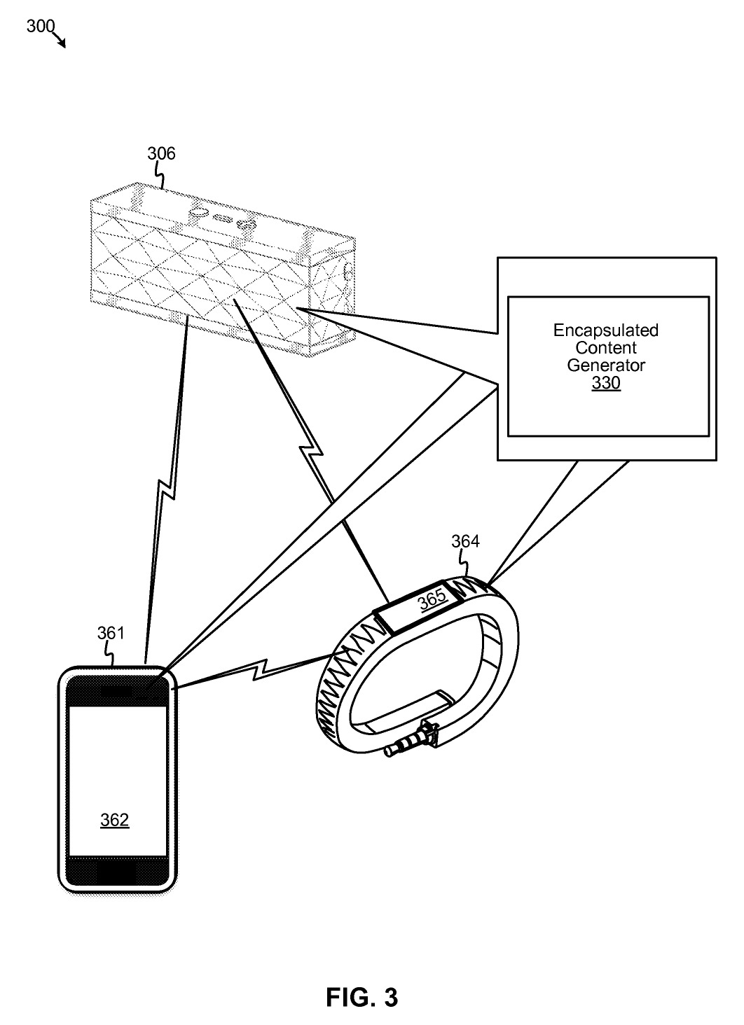

FIG. 3 is a diagram depicting examples of devices in which, or over which, structures and/or functions of an encapsulated content generator can be disposed, according to some embodiments. Diagram 300 depicts a media device 306, mobile computing device 361 with an interface 362, and a wearable device 364 including an interface 365. As shown, one or more portions/components of encapsulated content generator 330 can be disposed in one or more of media device 306, mobile computing device 361, and wearable device 364, as well as in any other devices.

Examples of components or elements of an implementation of media device 306 are disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 806 is not limited to presenting audio, but rather can present both visual information, including video (e.g., using a pico-projector digital video projector or the like) or other forms of imagery along with (e.g., synchronized with) audio. An example of a suitable wearable device 364, or a variant thereof, is described in U.S. patent application Ser. No. 13/454,040, which is incorporated herein by reference.

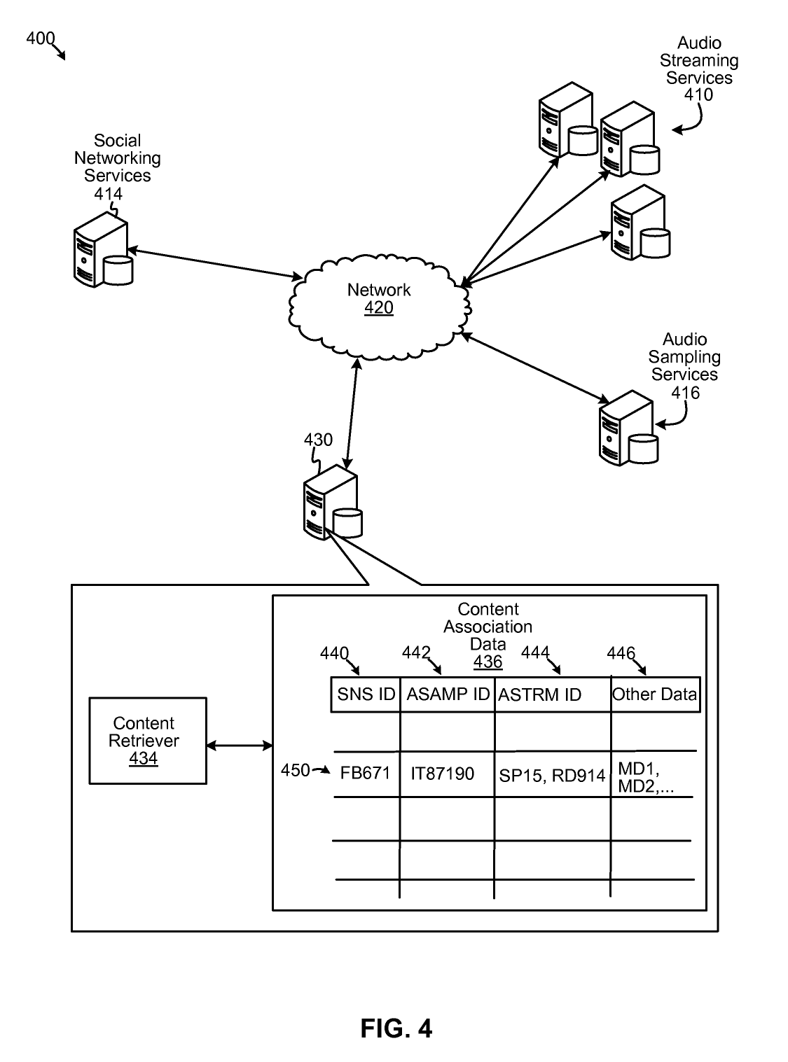

FIG. 4 is a diagram depicting an example of a content retriever, according to a specific example. Diagram 400 depicts an encapsulated content computing system 430 communicatively coupled via network 420 to a system of social networking services 414 (e.g., one or more networked social networking services 414), audio streaming services 410, and audio sampling services 416. For illustrative purposes, consider that social networking services 414 includes a platform managed by Facebook™, the platform including APIs associated with at least “graph” and “open graph” processes in which data representing social relationships and associations are stored, along with other information (e.g., information related to music such as listening histories, Facebook song IDs 440, song-related metadata, etc.). Examples of other social networking services, include, but are not limited to, services such as Yahoo! IM™, GTalk™, MSN Messenger™, Twitter® and other private or public social networks.

Audio streaming services 410 are platforms configured to provide audio/music streaming, such as Spotify™, Rdio™, Songza™, etc., via one or more APIs. Such audio streaming, services 410 can provide audio tracks songs reference by proprietary song IDs, and other metadata. Examples of proprietary song IDs include ASTRM IDs (“Audio Streaming Identifier”) 444 associated with “SP15” (e.g., unique identifier for Spotify) and “RD914” (e.g., unique identifier for Rdio). Audio sampling services 416 are platforms configured to provide samples of audio/music streaming, an example of which is iTunes™. In this example, audio sampling services 416 may provide unique proprietary song ID, such as ASAMP ID (“Auto Sampling Identifier”) 442 of “IT87190.”

Content retriever 434 is configured to access content association data file 436 to identify the various song IDs (e.g., 440, 442, 444) and other data 446 (e.g., metadata MD1, MD2) associated with content, such as a song 450. Thus, content retriever 434 can identify (e.g., in a look-up operation) the various song identifiers (or track identifiers). Therefore, an encapsulated content generator (not shown) can match Facebook data for a friend (e.g., Facebook song ID) against a personally-used Facebook song ID to determine a commonly-played song and frequency. Content retriever 434 can use that unique song ID to determine another unique song ID with which to pull a sample of the song from audio sampling services 416.

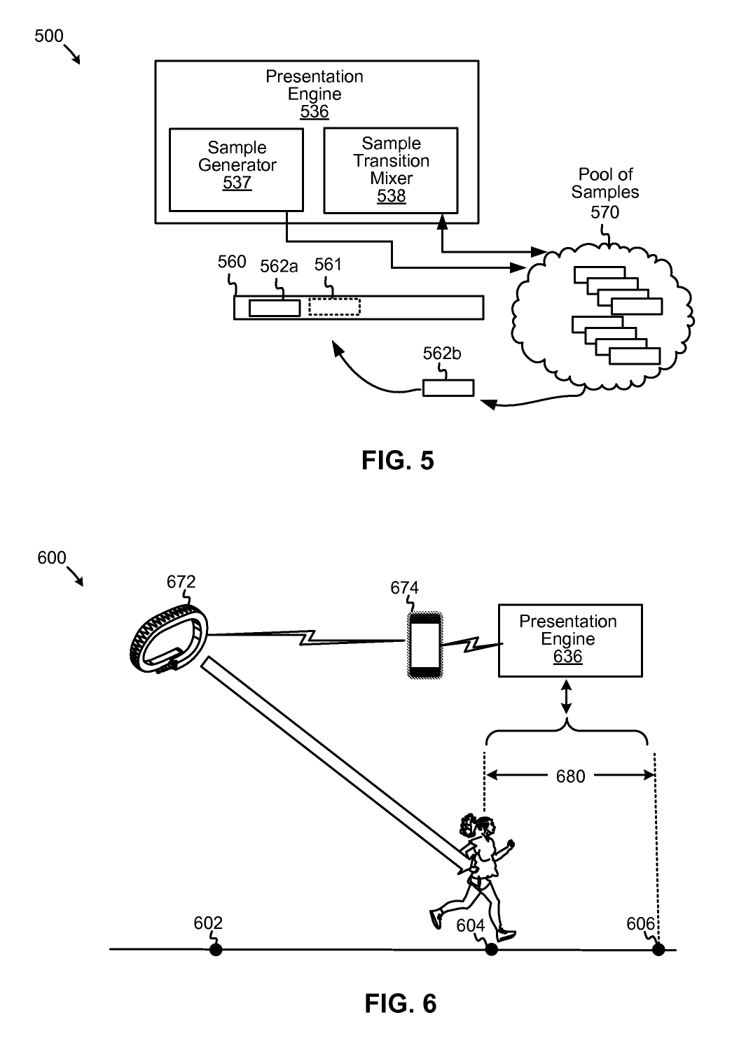

FIG. 5 is a diagram depicting a process of forming a digest, according to some examples. FIG. 500 includes a presentation engine 536, which, in turn, includes a sample generator 537 and a sample transition mixer 538. Presentation engine 536 interacts with a pool of samples 570 to determine digest 560. In this example, sample generator 537 matches, for example, portion 562a against other samples or portions in pool 570, to determine a closely-related portion as a function of one or more parameters with which the degree of similarity is determined. For example, sample generator 537 determines that samples 562a and 562b are similar in terms of beats per minute, amounts of base, are in the same or equivalent, and the like. As such, sample generator 537 disposes sample 562b at position 561. Sample transition mixer 538 can operate, as described above in FIG. 1, to adopt an aurally-pleasing transition. In some cases, sample transition mixer 538 can be configured time-shift or either increase or decrease the length in which a portion is presented.

FIG. 6 is a diagram depicting a presentation engine, according to some examples. Diagram 600 depicts a user engage in an activity, such as running, and wearing a wearable computing device 672. Wearable computing device 672 is communicatively coupled to a mobile computing device 674, which, includes or is in communication with a presentation engine 636. In this example, user starts at point 602 and intends to end the run at destination point 606. When user is at intermediate point 604, wearable device 672 and mobile computing device 674 calculate a distance 680 until the user is done running. Responsive to a distance 680, presentation engine 636 can adjust the times of each sample of a digest to urge for playback of the digest terminate at around the time the user completes her run it point 606.

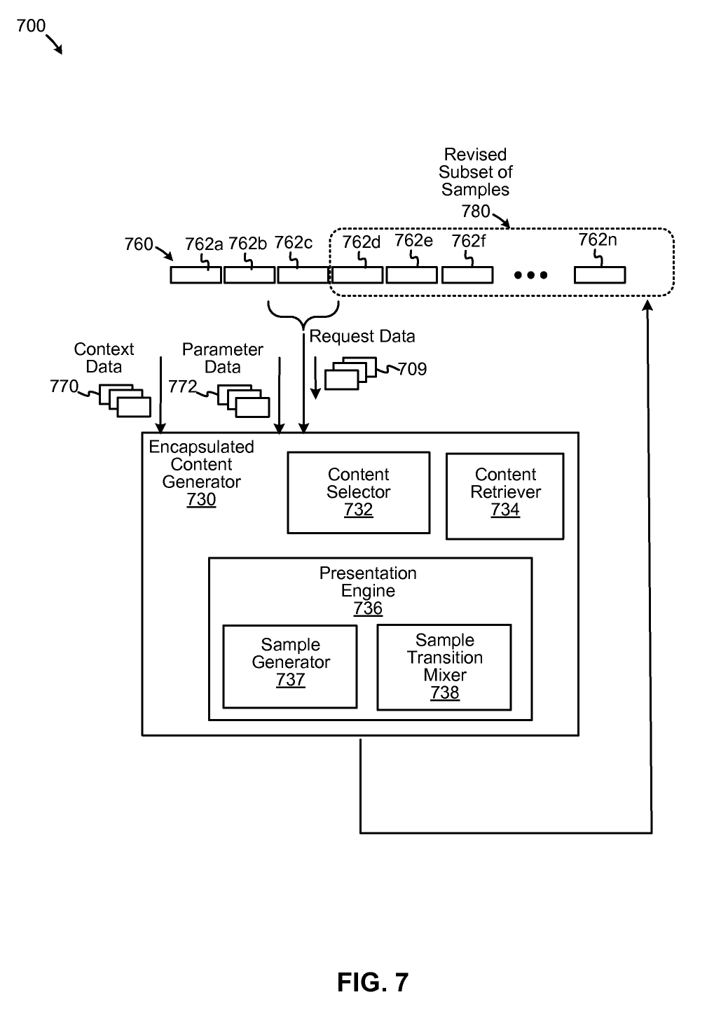

FIG. 7 is a diagram depicting a revised subset of samples, according to some examples. Diagram 700 includes a digest 760 composed of encapsulated content or portions 762a to 762n, and an encapsulated content generator 730 having similarly-named and/or similarly-numbered components as set forth in FIG. 1. Consider an example in which encapsulated content generator 730 perceives request data 709 coextensive with the presentation of portion 762c (e.g., user makes a request responsive to perceiving or consuming a sample song portion). Encapsulated content generator 730 can also receive context data 770 and parameter data 772. Should a value of a parameter change subsequent to the formation of digest 760, such as the time of day of the playback (daytime moves to nighttime), encapsulated content generator 730 can generate a revised subset of samples 780. Therefore, if portion 762a to 763n were identified by archived events occurring during the daytime, when playback is at nighttime (e.g., near bedtime), revised subset of samples 780 provides the listener with music more suitable for the evening.

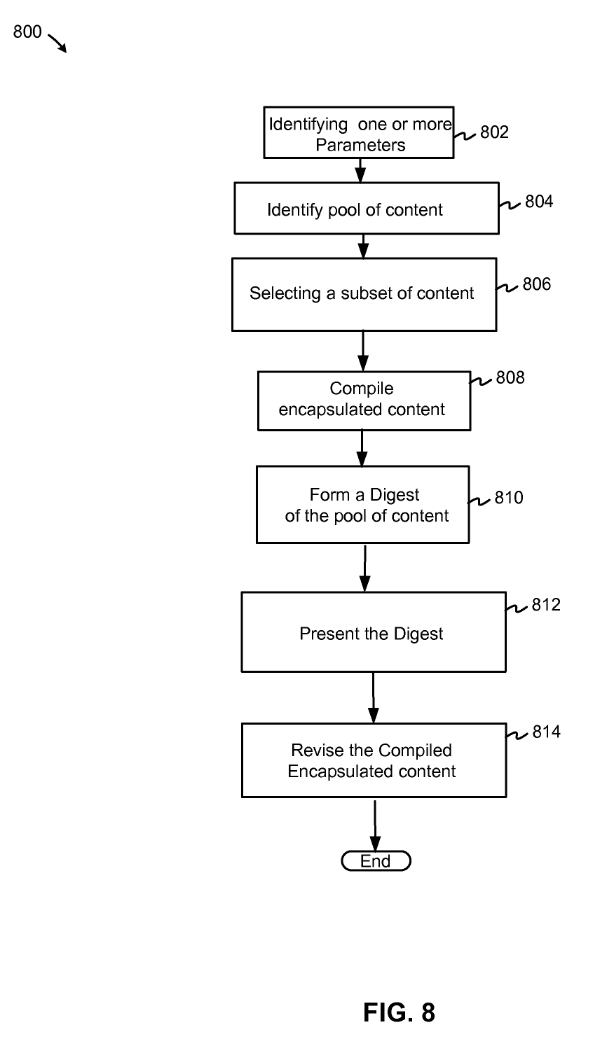

FIG. 8 is an example flow of generating encapsulated content for a pool of content, according to some embodiments. Flow 800 starts by identifying one or more parameters at 802 to select a subset of content, such as a group of songs that make up the top ten most-played songs by a listener. At 804, a pool of content is identified. At 806, a subset of content is selected, and encapsulated content is compiled at 808. At 810, a digest is formed for the pool of content. At 812, the digest is presented (e.g., an MP3 audio file is played), and at 814, a portion of the compiled encapsulated content (e.g., digest) can be revised.

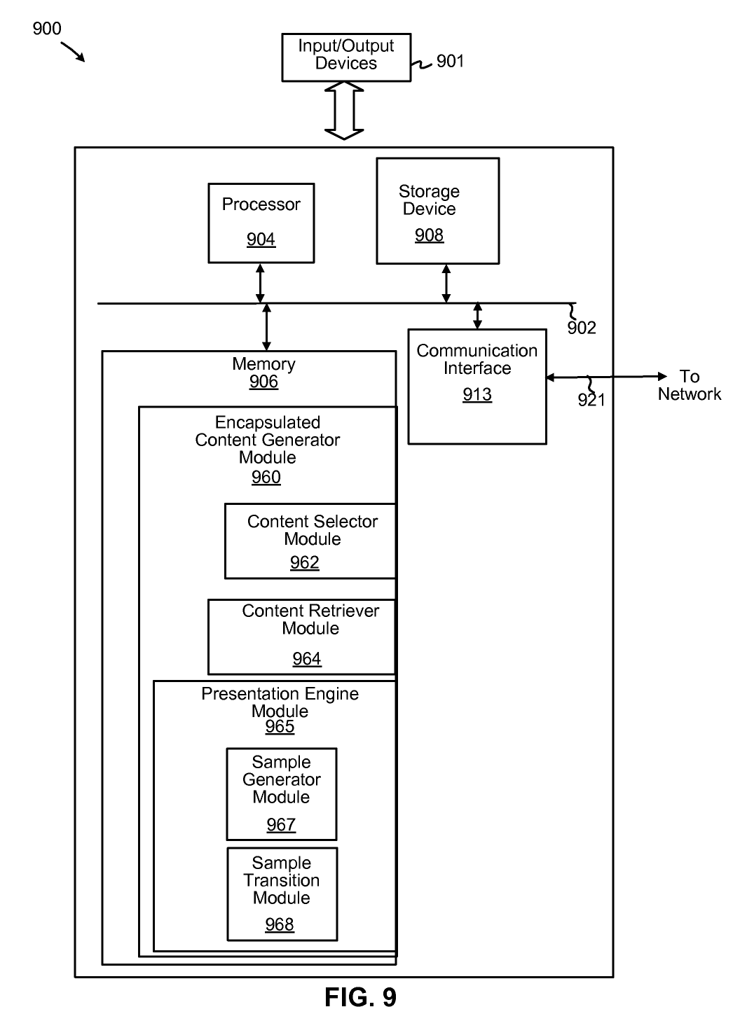

FIG. 9 illustrates an exemplary computing platform in accordance with various embodiments. In some examples, computing platform 900 may be used to implement computer programs, applications, methods, processes, algorithms, or other software to perform the above-described techniques. Computing platform 900 includes a bus 902 or other communication mechanism for communicating information, which interconnects subsystems and devices, such as processor 904, system memory 906 (e.g., RAM, etc), storage device 908 (e.g., ROM, etc.), a communication interface 913 (e.g., an Ethernet or wireless controller, a Bluetooth controller, etc.) to facilitate communications via a port on communication link 921 to communicate, for example, with a computing device, including mobile computing and/or communication devices with processors. Processor 904 can be implemented with one or more central processing units (“CPUs”), such as those manufactured by Intel® Corporation, or one or more virtual processors, as well as any combination of CPUs and virtual processors. Computing platform 900 exchanges data representing inputs and outputs via input-and-output devices 901, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like.

According to some examples, computing platform 900 performs specific operations by processor 904 executing one or more sequences of one or more instructions stored in system memory 906, and computing platform 900 can be implemented in a client-server arrangement, peer-to-peer arrangement, or as any mobile computing device, including smart phones and the like. Such instructions or data may be read into system memory 906 from another computer readable medium, such as storage device 908. In some examples, hard-wired circuitry may be used in place of or in combination with software instructions for implementation. instructions may be embedded in software or firmware. The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks and the like. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by computing platform 900. According to some examples, computing platform 900 can be coupled by communication link 921 (e.g., a wired network, such as LAN, PSTN, or any wireless network) to any other processor to perform the sequence of instructions in coordination with (or asynchronous to) one another. Computing platform 900 may transmit and receive messages, data, and instructions, including program code (e.g., application code) through communication link 921 and communication interface 913. Received program code may be executed by processor 904 as it is received, and/or stored in memory 906 or other non-volatile storage for later execution.

In the example shown, system memory 906 can include various modules that include executable instructions to implement functionalities described herein. In the example shown, system memory 906 includes an encapsulated content generator module 960, which, in turn, includes a content selector module 962, a content retriever module 964, a presentation engine 965, a sample generator 967, and a sample transition mixer 968.

According to specific embodiments, examples of one or more structures and/or functions may be described in System and Method for Personalized Recommendation and Optimization of Playlists, Provisional Patent Application No. 61/864,265, Filing Date: Aug. 5, 2013; System and Method for Audio Processing Using Arbitrary Triggers, Provisional Patent Application No. 61/844,488, Filing Date: Jul. 10, 2013, and Multiple Data Source Aggregation for Efficient Synchronous Multi-Device Media Consumption, Utility patent application Ser. No. 14/039,258, Filing Date: Sep. 27, 2013 all of which are incorporated by reference.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
identifying a pool of content as a function of a subset of parameters;
selecting a subset of content from the pool based on one or more of the parameters to compile data representing encapsulated content;
forming at a processor data representing a digest of the pool of content including the compiled encapsulated content; and
presenting the data representing the digest of the pool of content.

2. The method of claim 1, wherein identifying the pool of content comprises:
identifying the pool of content including a pool of data representing audio tracks.

3. The method of claim 1 wherein identifying the pool of content comprises:
identifying the pool of content based on a first parameter specifying data identifying one or more social relationships and content associated with the one or more social relationships.

4. The method of claim 1, wherein identifying the pool of content comprises:
identifying the pool of content based on a second parameter specifying data identifying physiological characteristics or proximity.

5. A method comprising:
retrieving graph data that includes data representing social relationships and data representing subsets of content, the content including, data representing audio tracks;
identifying a pool of content from multiple disparate sources of content as a function of the graph data;
determining a subset of the pool based on one or more parameters;
identifying sources of the audio tracks;
generating data representing samples of the audio tracks;
retrieving audio data for the samples of the audio tracks;
compiling samples to form a digest; and
presenting the digest.

6. The method of claim 5, wherein determining the subset of the pool based on the one or more parameters comprises:
generating a playlist based on the one or more parameters.

7. The method of claim 5, wherein generating the data representing the samples of the audio tracks comprises:
identifying a group of the audio tracks having a frequency of playback greater than a threshold amount; and
specifying a duration of a year during which the group of the audio tracks played,
wherein the digest represents a year-in-review summary of frequently played audio tracks.

8. The method of claim 6, wherein generating the data representing the samples of the audio tracks comprises:
encapsulating the audio tracks by identifying a portion of each of the audio tracks.

9. The method of claim 6, wherein compiling the samples to form the digest comprises:
determining an order with which to present the samples in the digest.

10. The method of claim 8, further comprising:
identifying parameters including music characteristics with which to determine the order; and
adapting one or more audio tracks to effect a transition between at least two audio tracks.

11. The method of claim 5, further comprising:
retrieving graph data including receiving data representing listening histories specifying archived events associated with interactions with audio data.

12. A system comprising:
a memory including one or more modules;
a processor to instructions stored in at least one of the modules;
a content selector configured to select a subset of content from the pool based on one or more of the parameters to compile data representing encapsulated content,
a presentation engine configured to determine an order of presenting the encapsulated content, and further configured to present data representing encapsulated audio in the order.

13. The system of claim 12, wherein the order of presentation is a function of time or ranking.

14. The system of claim 12, further comprising:
a content retriever configured to retrieve the selected subset of content or portions thereof.

15. The system of claim 12, wherein the content selector is further configured to identify the pool of content based on a parameter specifying data identifying one or more social relationships and content associated with the one or more social relationships.

16. The system of claim 12, wherein the content selector is further configured to identify a subset of the pool of content based on another parameter indicating that other individuals associated with the one or more social relationships to a user are in proximity to a user.

17. The system of claim 12, further comprising:
a sample generator configured to determine portions of the content to form the encapsulated content.

18. The system of claim 12, further comprising:
a sample transition mixer configured to form the digest in which an ordered pair of a first portion of content and a second portion of content, wherein the sample transition mixer is further configured to perform one or more of beat-matching, cross-fading, time-shifting, and bit-shifting to transition the presentation of the first portion of content to the second portion of content.

19. The system of claim 12, wherein one or more of the content selector, the content retriever, and the presentation engine comprise:
one or more of an one or more of a content selector circuit, a content retriever circuit, and a presentation engine circuit.
